(19) United States
(12) Patent Application Publication
(10) Pub. No.: US 2006/0280251 A1
(43) Pub. Date: Dec. 14, 2006

(54) Motion vector computing method

(75) Inventor: Pommy Hsieh, Shindian City (TW)

Correspondence Address: BIRCH STEWART KOLASCH & BIRCH, PO BOX 747, FALLS CHURCH, VA, 22040-0747, US

(73) Assignee: VIA TECHNOLOGIES, INC.

(21) Appl. No.: 11/447,985

(22) Filed: Jun. 7, 2006

(30) Foreign Application Priority Data
Jun. 8, 2005 (TW) 094118943

(51) Int. Cl. H04N 11/02; H04N 11/04; H04N 7/12; H04B 1/66

(52) U.S. Cl. 375/240.16; 375/240.24

(57) ABSTRACT

A motion vector computing method is applied to a video frame, which includes at least one video package having a plurality of blocks. The method includes the steps of: selecting a target block from the blocks; determining whether a first reference block, a second reference block and a third reference block corresponding to the target block are out of the boundaries of the video package so as to generate a result according to the position of the target block in the video package; and generating a prediction of a motion vector of the target block according to the result. In this case, the result indicates the first reference block, the second reference block and/or the third reference block that are/is not out of the boundaries of the video package.

### BACKGROUND OF THE INVENTION

1. Field of Invention

The invention relates to a motion vector computing method and, in particular, to a motion vector computing method with a reduced memory capacity.

2. Related Art

The compressed image, such as the MPEG image, achieves reduced data size to be stored or to be transferred by using motion vectors to present the difference between the two continuous video frames. In a newer image specification, the block may further store the differences between the motion vectors such that the amount of the image data may be further compressed.

As shown in FIG. 1, a video frame (non-hatched portion) having the size of 8×8 includes blocks 11 to 14. When the image data is being decoded, it is assumed that the current data includes a motion vector difference of the block 11 and motion vectors of the block 12 (the left of the block 11), the block 13 (the upper of the block 11) and the block 14 (the right-upper of the block 11). In this case, the motion vector corresponding to the block 11 has to be obtained according to the motion vectors of the blocks 12 to 14 by adding the motion vector difference of the block 11 to a median among the motion vectors of the blocks 12 to 14.

However, when the prior art is dealing with the boundaries of the video frame, problems will be caused because the reference block is located out of the video frame. To prevent the problems, the prior art tries to create additional blocks 15 (hatched portion) that may be referred in advance, such that the decoder or the decoding program can correctly get the median among the motion vectors of the reference blocks and correctly perform the decoding procedure.

However, the method of creating the additional blocks consumes a larger storage space in the memory. In particular, when a hardware decoding device has a limited memory capacity, the memory may be used more effectively if the data amount to be additionally stored is reduced.

Therefore, it is an important subject of the invention to provide a motion vector computing method that can reduce the required memory space.

### SUMMARY OF THE INVENTION

In view of the foregoing, the invention is to provide a motion vector computing method a with a reduced memory capacity.

To achieve the above, a motion vector computing method of the invention is applied to a video frame, which includes at least one video package having a plurality of blocks. The method includes the steps of: selecting a target block from the blocks; determining whether a first reference block, a second reference block and a third reference block corresponding to the target block are out of boundaries of the video package according to a position of the target block in the video package, so as to generate a result; and generating a prediction for computing a motion vector of the target block according to the result. In the invention, the result indicates the first reference block, the second reference block and/or the third reference block that are/is not out of the boundaries of the package.

In addition, a motion vector computing method of the invention is applied to a video frame, which includes at least one video package having a plurality of blocks. The method includes the steps of: selecting a target block from the blocks; determining whether a first reference block, a second reference block and a third reference block corresponding to the target block are out of boundaries of the video package according to a position of the target block in the video package; when the first reference block is not out of the boundaries of the video package, and the second reference block and the third reference block are out of the boundaries of the video package, generating a prediction according to a motion vector of the first reference block; when the first reference block and the second reference block are not out of the boundaries of the video package, and the third reference block is out of the boundaries of the video package, generating the prediction according to the motion vector of the first reference block and a motion vector of the second reference block; when the first reference block and the third reference block are not out of the boundaries of the video package, and the second reference block is out of the boundaries of the video package, generating the prediction according to the motion vector of the first reference block and a motion vector of the third reference block; when the third reference block is not out of the boundaries of the video package, and the first reference block and the second reference block are out of the boundaries of the video package, generating the prediction according to the motion vector of the third reference block; when the second reference block and the third reference block are not out of the boundaries of the video package, and the first reference block is out of the boundaries of the video package, generating the prediction according to the motion vector of the second reference block and the motion vector of the third reference block; and when the first reference block, the second reference block and the third reference block are not out of the boundaries of the video package, generating the prediction according to the motion vector of the first reference block, the motion vector of the second reference block and the motion vector of the third reference block.

As mentioned above, compared to the prior art, the motion vector computing method of the invention does not have to create the additional blocks, which are located out of the video frame and may be referred. Thus, the memory space for storing the blocks may be reduced, and the efficiency of using the memory may be accordingly enhanced.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing the conventional motion vector computing method;

FIG. 2 is a flow chart showing a motion vector computing method according to a preferred embodiment of the invention;

FIGS. 3A to 3E are schematic illustrations showing the motion vector computing method according to the preferred embodiment of the invention; and

FIGS. 4A to 4F are schematic illustrations showing possible positions of the target block in the motion vector computing method according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

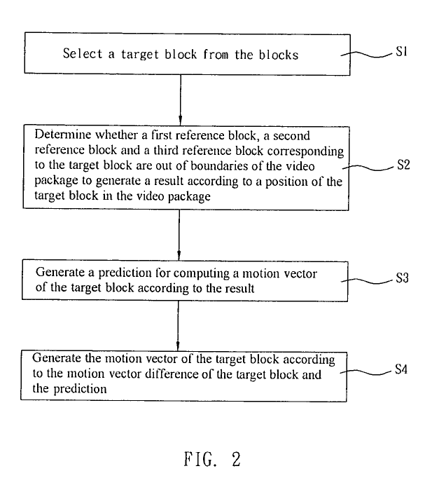

Referring to FIG. 2, a motion vector computing method according to a preferred embodiment of the invention is applied to a video frame, which includes at least one video package having a plurality of blocks, and includes the following steps S1 to S3.

Step S1 is to select a target block from the blocks of the video package.

Step S2 is to determine whether a first reference block, a second reference block and a third reference block corresponding to the target block are out of boundaries of the video package to generate a result according to a position of the target block in the video package. In the embodiment, the result indicates the first reference block, the second reference block and/or the third reference block that are/is not out of the boundaries of the video package.

Step S3 is to generate a prediction for computing a motion vector of the target block according to the result. Herein, the prediction is a median among the motion vector(s) of the first reference block, the second reference block and/or the third reference block that are/is not out of the boundaries of the package.

In this embodiment, the motion vector computing method further includes the following step S4, and the target block includes a motion vector difference.

Step S4 is to generate the motion vector of the target block according to the motion vector difference of the target block and the prediction. The motion vector of the target block can be calculated by referring to the following Equation 1:
MV=(MV difference)+reference (Equation 1)

MV: the motion vector of the target block

MV difference: the motion vector difference recorded by the target block

reference: the median among the motion vector(s) of the first reference block, the second reference block and/or the third reference block that are/is not out of the boundaries of the video package

After the motion vector of the target block has been computed, the target block may serve as one of a first reference block, a second reference block and a third reference block corresponding to a subsequent target block. In this embodiment, after the motion vector of the target block has been computed, the computed motion vector may be stored in the target block to replace the motion vector difference, which is previously stored in the target block, to serve as one of the first reference block, the second reference block and the third reference block for the subsequent target block. In this embodiment, the present invention may calculate the target block located at the boundary of the package by referring to the reference block(s) that is(are) not out of the boundary of the package in step S3. Accordingly, the motion vector computing method of the invention does not have to create the additional blocks, which are located out of the video package, so that the memory space for storing the blocks may be reduced.

As the relationship between the target block and the reference block(s) varies, the following descriptions will illustrate the different situations and which reference block(s) should be referred to calculate the prediction in these situations.

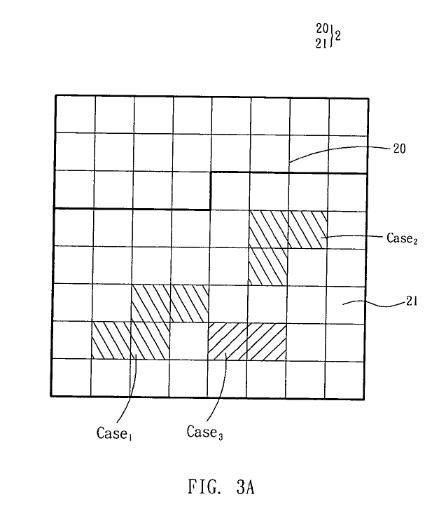

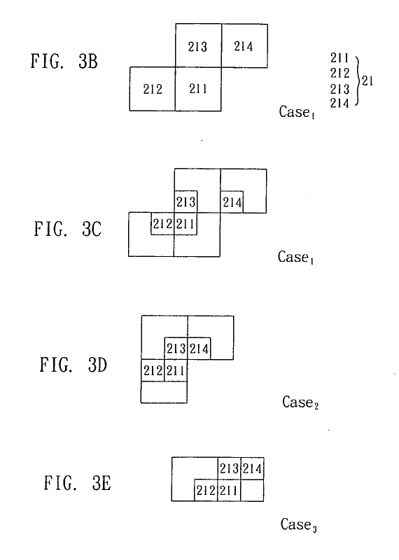

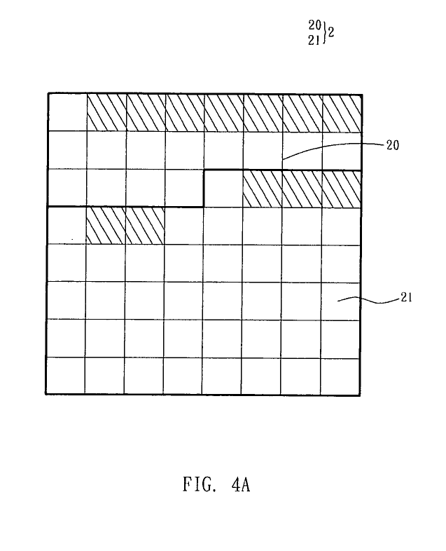

As shown in FIG. 3A, a video frame 2 of this embodiment may include a video package 21 and a video package 22, each of which includes a plurality of blocks. In another embodiment, the video frame may include one video package having a plurality of blocks.

As shown in FIGS. 3A to 3E, the video package 21 includes a target block 211, a first reference block 212, a second reference block 213 and a third reference block 214. The positional relationships among the target block 211, the first reference block 212, the second reference block 213 and the third reference block 214 are generally divided into the following cases of a first case Case₁, a second case Case₂ and a third case Case₃, as shown in hatched portions of FIG. 3A.

In the first case Case₁, as shown in FIGS. 3A and 3B, the first reference block 212 is located on the left of the target block 211 and has the same row with the target block 211. The second reference block 213 is located on the upper of the target block 211 and has the same column with the target block 211. The third reference block 214 is located on the right of the second reference block 213 and has the same row with the second reference block 213. In this embodiment, the target block 211, the first reference block 212, the second reference block 213 and the third reference block 214 are different blocks.

In the first case Case₁, as shown in FIGS. 3A and 3C, the target block 211, the first reference block 212, second reference block 213 and the third reference block 214 may be the sub-blocks in the blocks. The first reference block 212 is located on the left of the target block 211 and has the same row with the target block 211. The second reference block 213 is located on the upper of the target block 211 and has the same column with the target block 211. The third reference block 214 is located on the right of the second reference block 213 and has the same row with the second reference block 213. In this embodiment, the target block 211, the first reference block 212, the second reference block 213 and the third reference block 214 are respectively located at different sub-blocks in different blocks.

In the second case Case₂, as shown in FIGS. 3A and 3D, the first reference block 212 is located on the left of the target block 211 and has the same row with the target block 211 in different sub-blocks of the same block. The second reference block 213 is located on the upper of the target block 211 and has the same column with the target block 211. The third reference block 214 is located on the right of the second reference block 213 and has the same row with the second reference block 213. In this embodiment, the target block 211 and the first reference block 212 are located at the same block, and the first reference block 212, the second reference block 213 and the third reference block 214 are respectively located at different blocks.

In the third case Case₃, as shown in FIGS. 3A and 3E, Herein, the target block 211, the second reference block 213 and the third reference block 214 are located at the same block, and the target block 211 and the first reference block 212 are respectively located at different blocks.

In addition, the data may be sequentially stored in the memory in advance without additional blocks, which are located out of the video frame and may be referred during the decoding procedure, being added. Therefore, it is unnecessary to read the additional data corresponding to the additional blocks out of the video frame when the target block or the reference blocks are read. Regarding to the hardware device, the above mentioned storing method for the data of the blocks may reduce the required memory space.

Furthermore, the target block may located at the edge of the video package 21, so that the corresponding reference block may located out of the region of the video package 21. In this case, the selected reference block may be decided depending on the location of the target block for calculating the motion vector, which will be described herein below with reference to the drawings.

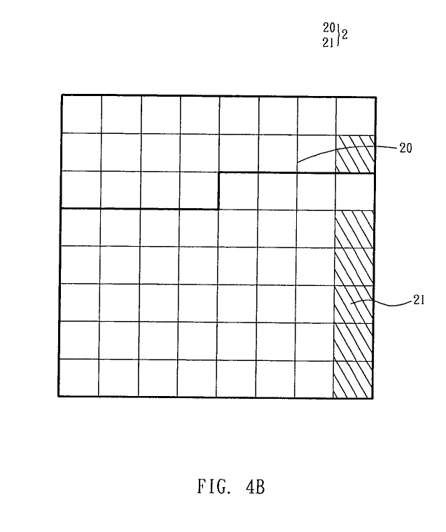

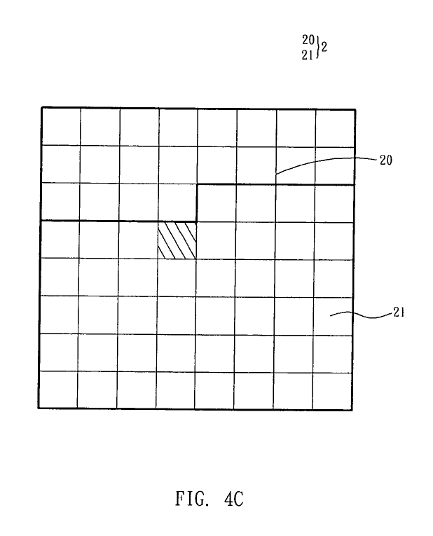

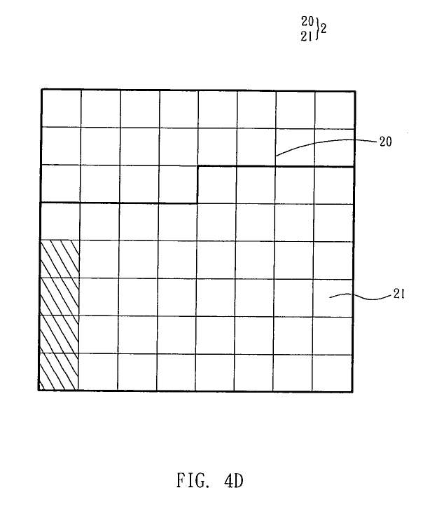

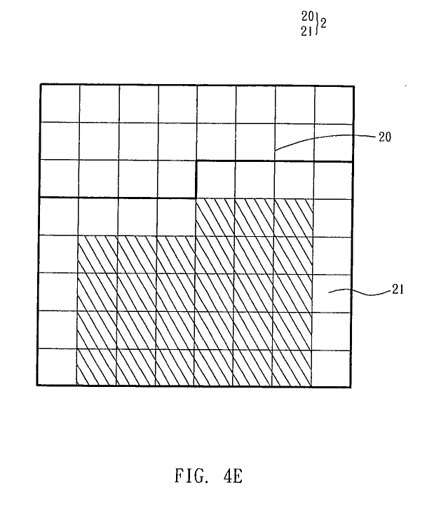

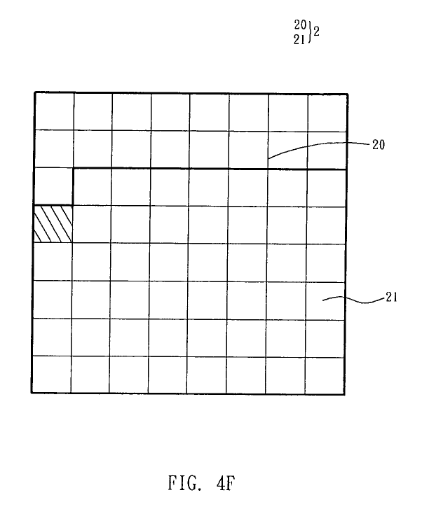

As shown in FIG. 4A, when the target block is located at a topmost row of the video package (the upper hatched portion in the drawing), the first reference block is not out of the boundaries of the video package and the second reference block and the third reference block are out of the boundaries of the video package. In the step S3 the prediction is provided according to the motion vector of the first reference block. That is, only one reference block (the first reference block) located at one column in front of the target block has to be referred for calculating the target block. The processor computes the motion vector difference of the target block and the prediction to generate a computed motion vector of the target block, which is stored in a memory, or may be stored in a register of the processor. The stored motion vector can serve as a reference block for a next target block. Thus, the reference block stored in the register may be directly read when the motion vector of the next target block is computed. Therefore, it is unnecessary to read the memory and it is possible to shorten the time by accessing the memory for enhancing the performance.

In addition, as shown in FIG. 4B, when the target block is not located at the topmost row of the video package and is located at the rightmost column (the right hatched portion in the drawing), the first reference block and the second reference block are not out of the boundaries of the video package and the third reference block is out of the boundaries of the video package. In step S3, the prediction is provided according to the motion vectors of the first reference block and the second reference block. That is, only two reference blocks (the first reference block and the second reference block) respectively located at one column in front of the target block and at one row in front of the target block have to be referred for calculating the target block. As shown in FIG. 4C, when the target block is located at the next row of the junction of two video packages (the hatched portion in the drawing), the first reference block and the third reference block are not out of the boundaries of the video package and the second reference block is out of the boundaries of the video package. In step S3, the prediction is provided according to the motion vectors of the first reference block and the third reference block. That is, only two reference blocks (the first reference block and the third reference block) respectively located at one column in front of the target block and at one row in front and one column in back of the target block have to be referred for calculating the target block. As shown in FIG. 4D, when the target block is not located at the topmost row of the video package and is located at the leftmost column (the left hatched portion in the drawing), the second reference block and the third reference block are not out of the boundaries of the video package and the first reference block is out of the boundaries of the video package. In step S3, the prediction is provided according to the motion vectors of the second reference block and the third reference block. That is, only two reference blocks (the second reference block and the third reference block) respectively located at one row in front of the target block and at one row in front and one column in back of the target block have to be referred for calculating the target block. As shown in FIG. 4E, when the target block is located at the hatched portion in the drawing, the first reference block, the second reference block and the third reference block are not out of the boundaries of the video package. In this case, the prediction is generated according to the motion vectors of the first reference block, the second reference block and the third reference block. In this embodiment, the prediction may be generated according to a median among the motion vectors of the first reference block, the second reference block and the third reference block. Herein, three reference blocks (the first reference block, the second reference block and the third reference block) respectively located at one column in front of the target block, at one row in front of the target block and at one row in front and one column in back of the target block have to be referred for calculating the target block. As shown in FIG. 4F, when the target block is located at the next row of the junction of two video packages and at the leftmost column (the hatched portion in the drawing), the third reference block is not out of the boundaries of the video package and the first reference block and the second reference block are out of the boundaries of the video package. In step S3, the prediction is provided according to the motion vector of the third reference block. That is, only one reference block (the third reference block) located one row in front and one column in back of the target block has to be referred for calculating the target block.

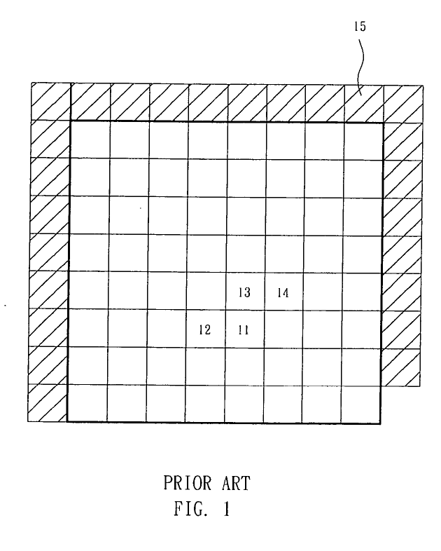

In an image having the standard DVD format, for example, 25 video frames have to be played in one second. One video frame may have at most 36 blocks in the vertical direction. Each block has four blocks, and each block is stored with 4 bits. The memory does not have to be read or written again when the motion vectors of the topmost row of the macro blocks are computed. Compared to the prior art, no additional memory is needed for storing the data of the motion vectors corresponding to the blocks (such as the hatched portion of FIG. 1) in front of the first column, in front of the first row, in back of the last column, or in back of the last row. Thus, the memory access amount saved per second by the method of this embodiment for computing the motion vector is represented by Equation 2:
(read/write access)×(blocks in one block)×(first/last column)×((macro blocks vertical number)−1)×(frames per second)×(memory capacity for one block)=25×(36−1)×4×4×2×2=56000 (bits/second) (Equation 2)

In summary, compared to the prior art, the motion vector computing method of the invention does not have to create the additional blocks, which are located out of the video frame and may be referred. Thus, the memory space for storing the blocks may be reduced, and the efficiency of using the memory may be accordingly enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A motion vector computing method applied to a video frame, wherein the video frame comprises one video package having a plurality of blocks, the method comprising the steps of:
selecting a target block from the blocks;
determining whether a first reference block, a second reference block and a third reference block corresponding to the target block are out of boundaries of the video package according to a position of the target block in the video package for generating a result, wherein the result indicates the first reference block, the second reference block and/or the third reference block that are/is not out of the boundaries of the video package; and
generating a prediction for computing a motion vector of the target block according to the result.

2. The method according to claim l, wherein the target block has a motion vector difference, and the method further comprises the step of:
generating the motion vector of the target block according to the motion vector difference of the target block and the prediction.

3. The method according to claim 1, wherein the step of generating the prediction for computing the motion vector of the target block according to the result comprises:
when the first reference block is not out of the boundaries of the video package, and the second reference block and the third reference block are out of the boundaries of the video package, the prediction is generated according to a motion vector of the first reference block.

4. The method according to claim 1, wherein the step of generating the prediction for computing the motion vector of the target block according to the result comprises:
when the first reference block and the second reference block are not out of the boundaries of the video package, and the third reference block is out of the boundaries of the video package, the prediction is generated according to a motion vector of the first reference block and a motion vector of the second reference block.

5. The method according to claim 1, wherein the step of generating the prediction for computing the motion vector of the target block according to the result comprises:
when the first reference block and the third reference block are not out of the boundaries of the video package, and the second reference block is out of the boundaries of the video package, the prediction is generated according to a motion vector of the first reference block and a motion vector of the third reference block.

6. The method according to claim 1, wherein the step of generating the prediction for computing the motion vector of the target block according to the result comprises:
when the third reference block is not out of the boundaries of the video package, and the first reference block and the second reference block are out of the boundaries of the video package, the prediction is generated according to a motion vector of the third reference block.

7. The method according to claim 1, wherein the step of generating the prediction for computing the motion vector of the target block according to the result comprises:
when the second reference block and the third reference block are not out of the boundaries of the video package, and the first reference block is out of the boundaries of the video package, the prediction is generated according to a motion vector of the second reference block and a motion vector of the third reference block.

8. The method according to claim 1, wherein the step of generating the prediction for computing the motion vector of the target block according to the result comprises:
when the first reference block, the second reference block and the third reference block are not out of the boundaries of the video package, the prediction is generated according to a motion vector of the first reference block, a motion vector of the second reference block and a motion vector of the third reference block.

9. The method according to claim 1, wherein the prediction is generated according to a median among the motion vector of the first reference block, the motion vector of the second reference block and the motion vector of the third reference block.

10. The method according to claim 1, wherein the target block is a sub-block in a block.

11. The method according to claim 1, wherein the first reference block is located on the left of the target block and has the same row of the target block, the second reference block is located on the upper of the target block and has the same column with the target block, and the third reference block is located on the right of the second reference block and has the same row with the second reference block.

12. A motion vector computing method applied to a video frame, wherein the video frame comprises at least one video package having a plurality of blocks, the method comprising the steps of:
selecting a target block from the blocks;
determining whether a first reference block, a second reference block and a third reference block corresponding to the target block are out of boundaries of the video package according to a position of the target block in the video package; and
when each of the first reference block, the second reference block, and the third reference block are not out of the boundaries of the video package, the prediction is provided according to the motion vector of the specific reference block.

13. The method according to claim 12, wherein when the first reference block, the second reference block and the third reference block are not out of the boundaries of the video package, the prediction is generated according to a median among the motion vector of the first reference block, the motion vector of the second reference block and the motion vector of the third reference block.

14. The method according to claim 12, wherein the target block has a motion vector difference, and the method further comprises the step of:
generating the motion vector of the target block according to the motion vector difference of the target block and the prediction.

15. The method according to claim 12, wherein the target block is a sub-block in a block.

16. The method according to claim 12, wherein the first reference block is located on the left of the target block and has the same row of the target block, the second reference block is located on the upper of the target block and has the same column with the target block, and the third reference block is located on the right of the second reference block and has the same row with the second reference block.
